(19) United States
(12) Patent Application Publication
(10) Pub. No.: US 2025/0345162 A1
(43) Pub. Date: Nov. 13, 2025

(54) DENTAL GAUGE

(71) Applicant: Marshall Hanson, Draper, UT (US)

(72) Inventor: Marshall Hanson, Draper, UT (US)

(21) Appl. No.: 18/658,897

(22) Filed: May 8, 2024

(51) Int. Cl. A61C 19/04

(52) U.S. Cl. CPC A61C 19/04

(57) ABSTRACT

There is a dental gauge configured to measure from a midline to a width of a contra-lateral tooth to determine symmetry, comprising: a bi-lateral adjustment mechanism, including a first arm and a second arm functionally coupled to a selectably adjustable bi-lateral spacing adjustor that simultaneously adjusts a relative lateral positioning of each of the first arm and the second arm such that adjustments of the first and second arm are identical in amount and opposite in lateral direction; a first post fixedly coupled to and extending from the first arm; a second post fixedly coupled to and extending from the second arm; and a midline post fixedly coupled to and extending from the bi-lateral adjustment mechanism such that adjustment of the mechanism does not change position of the midline post.

### BACKGROUND OF THE INVENTION

### Field Of The Invention

The present invention relates to dental devices, specifically dental calipers and gauges for measuring distances and providing symmetry.

### Description Of The Related Art

In the related art, it has been known to use calipers and gauges to measure angles and distances for dental repair and other dental procedures. Dental prostheses such as crowns, bridges, veneers, dentures and related dental procedures are well known in the art for restoring damaged or missing teeth within the mouth of a patient. In general terms, the area to be restored is initially prepared by the dentist, such as by reducing a damaged tooth by drilling and shaping procedures, to form a suitable base adapted to receive and support a prosthetic crown. The prepared area including adjacent and opposing tooth and gum structures is then replicated by means of dental impression defined typically by a curable vinyl elastomer or the like carried on a suitably shaped impression tray which is placed into the patient's mouth for the duration of a short cure cycle. The dental impression is then used to form the appropriate mold or molds from which the desired dental prosthesis is formed, normally from a castable gold alloy or the like. Other types of dental prostheses may require an imprint of the patient's bite registration.

Many types of calipers permit reading out a measurement on a ruled scale, a dial, or a digital display. A caliper may be referred to as a gauging device. A caliper may have two jaws (or probes, or arms) extending from an elongate member. Typically, one of the jaws is fixed to the elongate member, the other jaw is movable along the elongate member. A scale with indicia, such as a millimeter scale may be provided on the elongate member so that the distance between the jaws can be read. (Some calipers have digital readout devices incorporated therein rather than, or in addition to the indicia on the elongate member.)

A conventional caliper may have an elongate member with two sets of probes. One of each set of probes may be fixed to the elongate member, the other may be movable back and forth on the elongate member. A scale may be provided on the elongate member for displaying a measurement. The caliper may include: a first set of probes may extend in one direction (such as downward) from the elongate member and may be suitable for being positioned on the outside of an object, such as for measuring the outside diameter (OD) of the object, or the distance between two exterior points on the object. The maximum size object that may be measured in this manner may be limited by the length of the elongate member. A second set of probes may extend in another direction (such as upward) from the elongate member and may be suitable for being positioned on the inside of an object, such as for measuring the inside diameter (OD) of the object, or the distance between two interior points on the object. The minimum size object that may be measured in this manner may be limited by the size of the probes, which must fit within the space between the two points being measured on the object.

Typically, in use, the caliper is positioned so that the two jaws (or probe tips, or the like) are disposed at the two points (i.e., the distance therebetween) being measured, the caliper is removed, and the distance is read. Of course, the distance may be read with the caliper yet engaged with the object being measured. Some improvements have been made in the field. Examples of references related to the present invention are described below in their own words, and the supporting teachings of each reference are incorporated by reference herein:

U.S. Pat. No. 4,277,237, issued to Dermer, discloses a dental instrument for facilitating the selection and implantation of a generally U-shaped denture-supporting implant frame with bendable sidearms. The instrument is generally similar to bow dividers but is provided with an extensible calibrated distance bar which is supported for longitudinal adjustment in a median plane perpendicular to the plane of the main divider legs for movement parallel thereto, the distance bar having a pointed depending arm to locate a front center point on a patient's mandible adapted to receive an implantable front lug on the implant frame. This enables necessary data to be obtained for selecting the proper size of implant frame and for shaping the side arms of the implant frames so that they correspond with the shape of the patient's mandible.

U.S. Pat. No. 4,725,228, issued to Andrews, discloses a tooth crown marking device is comprised of markers at each end. The marker at one end is for marking a specified vertical landmark on the face of a tooth crown. The marker at the other end is for marking the horizontal center of a tooth crown. At that end, there is a pair of locating members adjustably mounted on either side of the horizontal marking arm in such a manner that the marking arm is maintained equidistant from the locating members. Pointers at the end of each locating member are adjusted to span the height of the crown. The horizontal center of a tooth crown is then marked by the marking arm which may be movably mounted on a support column along which the two locating members are mounted or mounted to the support column by a swivel arm.

U.S. Pat. No. 4,822,277, issued to Nevell, discloses an orthodontic apparatus comprising a divider like device with three arms. The outer arms operate in normal fashion while the central arm is coupled to the adjusting wheel so that its relative position with respect to the outer arm is constant. The central arm has a bracket retaining reverse tweezer arrangement for holding and positioning orthodontic brackets on teeth. In use the outer arms are located on either side of the tooth and the central arm locates the bracket in the correct position for fixing to the tooth.

U.S. Pat. No. 6,726,472, issued to Kuhn, discloses, a gauge for measuring and/or marking teeth or models of teeth for the determination of the placement of attachments for orthodontic braces. The gauge has a first arm with a gauge element with a longitudinal extension portion lying on a first axis and a vertical extension portion extending generally perpendicularly from the first axis of the longitudinal extension portion. The gauge has a second arm which has a pointer or marking element at an end thereof, the pointer element having a tip which is spaced apart from the longitudinal extension portion of the first arm, the first and second arm being connected together to maintain the spaced apart relationship between the tip of the marking element and the longitudinal extension portion with the vertical extension portion extending towards the pointer or marking element. The invention also provides a gauge element for converting a bow divider into a gauge for measuring and/or marking teeth for the determination of the placement of attachments for orthodontic braces. The gauge element has an elongate extension portion lying on a first axis and a vertical extension portion extending generally perpendicular to the first axis of the elongate extension portion with the vertical extension portion extending outwardly between about 2.00 mm and 3.00 mm from the longitudinal extension portion.

Japanese Patent No.: JP4786694B2, assigned to GC Corp, discloses a caliper-type bracket positioning marker for measuring the length necessary to determine the position to mount the orthodontic bracket and marking the part where the predetermined position of the bracket is located, A slider (2) slidable with respect to the main scale (1), a slider fixing portion (2b) for fixing the position of the slider (2), and a measurement surface (1aa) of the main scale side jaw (1a) A digital display unit (3) is provided to display the distance between the slider side jaw (2a) and the measurement surface (2aa), and the marker core (4) is attached to the main scale side jaw (1a) in the direction of its axis. Of the main scale side jaw (1a) so that it is parallel to the measurement surface (1aa) and the tip thereof is positioned on a substantially extended line of the measurement surface (1aa) of the main scale side jaw (1a). A caliper-type bracket positioning marker characterized in that a marker core holding and fixing portion (5) to be held and fixed at the tip of (1a) is provided. A space (6) for exposing the rear end side of the marker core (4) held by the marker core holding/fixing part (5) to protrude from the marker core holding/fixing part (5) is a main scale side jaw (1a The caliper type bracket positioning marker according to claim 1, which is provided on the rear end side.

The inventions heretofore known suffer from a number of disadvantages which include: not being able to easily visualize a measurement, not having a more predictable measurement, not being easy to use, not being more precise, not being easily stabilized, not providing a more accurate reading, not being easy to hold or easy to center, and not allowing for curved arch measurements.

What is needed is a dental gauge that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available calipers and/or gauges. Accordingly, the present invention has been developed to provide a dental gauge that may be configured to measure from a midline to a width of a contra-lateral tooth to determine symmetry.

In one embodiment, the dental gauge may include: a bi-lateral adjustment mechanism, that may have a first arm and/or a second arm that may be functionally coupled to a selectably adjustable bi-lateral spacing adjustor that may simultaneously adjust a relative lateral positioning of each of the first arm and/or the second arm such that adjustments of the first and/or second arm are identical in amount and/or opposite in lateral direction; a first post that may be fixedly coupled to and/or may be extending from the first arm; a second post that may be fixedly coupled to and/or may be extending from the second arm; and/or a midline post that may be fixedly coupled to and/or may be extending from the bi-lateral adjustment mechanism such that adjustment of the mechanism may not change position of the midline post.

In another embodiment the first post, second post, and/or midline post may each have an end region, and/or wherein the end regions of the first post, second post, and/or midline post may form a single continuous line. Further, in one embodiment, the bi-lateral adjustment mechanism may include an adjustment knob that may be functionally coupled between the arms, such that turning the knob may cause the arms to move in concert with one another. Also, in an embodiment, the bi-lateral spacing adjustor may include a gear that may have teeth functionally coupled to the knob and/or to the arms.

Additionally, in an embodiment of the invention, the bi-lateral adjustment mechanism may include an adjustment knob that may have the midline post extending therefrom. In a further embodiment, the midline post may include a gear that may have teeth disposed thereon, wherein the gear may be functionally coupled to the arms such that turning the knob may cause the arms to move in concert with one another. In still another embodiment, the first arm may include a front plate, and/or the second arm may include a rear plate. Also, in an embodiment, the front plate may include a female track, and/or the rear plate may include a male track such that the front plate and/or the rear plate may be slidably coupled together. In yet another embodiment, the front plate and/or the rear plate may each include a track disposed along a surface of each plate, and/or the selectably adjustable bi-lateral spacing adjustor may include a gear with teeth such that as the gear is turned, each plate may slide a distance that is identical in amount and opposite in direction.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a top plan view of a dental gauge, according to one embodiment of the invention;

FIG. 2 is a top plan view of a dental gauge, according to one embodiment of the invention;

FIG. 3 is a top plan view of a first arm of a dental gauge with a second arm removed, according to one embodiment of the invention;

FIG. 4A is a side elevational view of a first end of a first arm, according to one embodiment of the invention;

FIG. 4B is a side elevational view of a first end of a second arm, according to one embodiment of the invention;

FIG. 5A is a side elevational view of a first end of a first arm, according to one embodiment of the invention;

FIG. 5B is a side elevational view of a first end of a second arm, according to one embodiment of the invention; and

FIG. 6 is a perspective view of a dental gauge, showing the dental gauge measuring a tooth, according to one embodiment of the invention.

### DETAILED DESCRIPTION OF THE INVENTION

For the purpose of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

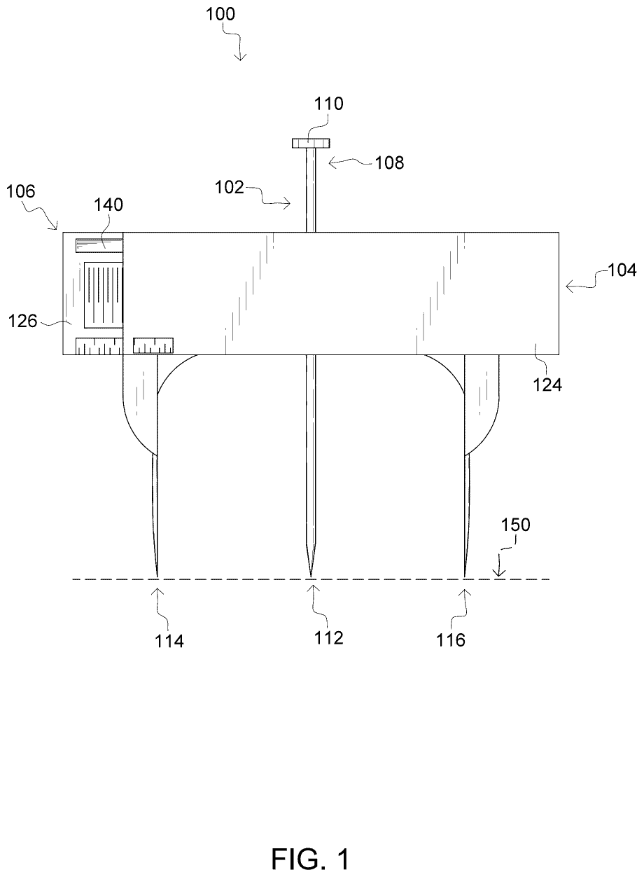

FIG. 1 illustrates a top plan view of a dental gauge, according to one embodiment of the invention. There is shown a dental gauge 100 with a bi-lateral adjustment mechanism 102. The bi-lateral adjustment mechanism 102 is disposed between, and functionally coupled to, a first arm 104 and a second arm 106. The bi-lateral adjustment mechanism 102 includes: a bi-lateral spacing adjustor 108, an adjustment knob 110, and a midline post 112 extending therefrom. The first arm 104 includes a first post 114 coupled to the first arm 104 and extending therefrom. The second arm 106 includes a second post 116 coupled to the second arm 106 and extending therefrom. The first arm 104 also has a front plate 124, and the second arm 106 also has a rear plate 126. The front plate 124 and the rear plate 126 may be coupled together along a track 140.

The illustrated dental gauge 100 may be configured to measure from a midline of a set of teeth in a mouth to a contra-lateral tooth to determine symmetry. As shown, the dental gauge 100 includes the bi-lateral adjustment mechanism 102, including the first arm 104 and the second arm 106. The first arm 104 and the second arm 106 are each functionally coupled to the bi-lateral spacing adjustor 108. Accordingly, the arms 104 and 106 may be any extension or projection from the bi-lateral adjustment mechanism 102.

In addition, there is illustrated the first post 114 fixedly coupled to and extending from the first arm 104, and the second post 116 fixedly coupled to and extending from the second arm 106. Further illustrated, the midline post 112 is fixedly coupled to and extending from the bi-lateral adjustment mechanism 102. It is understood that the posts 112, 114, and/or 116 may be any extension, projection, or device for marking and measuring distances. For example, in one embodiment, the posts 112, 114, and/or 116 may be lines created by a laser.

In one embodiment, the bi-lateral spacing adjustor 108 may be selectably adjustable so that the bi-lateral spacing adjustor 108 simultaneously adjusts a relative lateral position of each of the first arm 104 and the second arm 106 such that the adjustments of the first and second arms 104 and 106, respectively, are identical in amount and opposite in lateral direction. More, adjustment of the bi-lateral adjustment mechanism 102 does not cause the midline post 112 to change position. The midline post 112 does not move and remains in constant position. Further shown, the pair of side posts 114 and 116 and the center post 112 each have an end region 150. The end regions 150 of the posts 112, 114, and 116 form a single continuous line. As shown, the end regions 150 are at an end opposite the adjustment knob 110.

The bi-lateral adjustment mechanism 102 also includes a bi-lateral spacing adjustor 108 and an adjustment knob 110. Accordingly, the top of the bi-lateral adjustment mechanism 102 may include a flat, circular adjustment knob 110 for rotating the bi-lateral spacing adjustor 108. In one non-limiting embodiment, the bi-lateral spacing adjustor 108 may include a gear. As the bi-lateral spacing adjustor 108 rotates, each of the first arm 104 and the second arm 106 may move in a lateral direction opposite to the respective arm.

For example, in operation of one embodiment the bi-lateral adjustment mechanism 102 with bi-lateral spacing adjustor 108 and adjustment knob 100 may be rotated clockwise. As the bi-lateral adjustment mechanism 102 is rotated clockwise, the first arm 104 and second arm 106 may slide in a lateral direction so that the first post 114 and the second post 116 move away from one another an equal distance from the midline post 112. To move the first post 114 and the second post 116 toward one another, the bi-lateral adjustment mechanism 102 may be rotated counter-clockwise. The bi-lateral adjustment mechanism 102 may be rotated to move the first post 114 and the second post 116 until there is no measurable distance between posts 114 and 116 and the midline post 112. Accordingly, the arms 104 and 106 move in lock-step thereby moving posts 114 and 116 either away from or towards the midline post 112.

In one embodiment, the dental gauge 100 may be operated as a symmetry tool to measure and establish widths of contra-lateral teeth across a midline, such as between two front teeth, thereby allowing one to visualize and achieve dental symmetry around an arch, U-shape, curvature, etc. As the dental gauge 100 is operated, the midline post 112 may be aligned with a midline in a mouth. A measurement may be taken as a distance from the midline post 112 to a width of a contra-lateral tooth in order to determine symmetry. If it is determined that there is no symmetry, one may alter the shape of the contra-lateral tooth to achieve symmetry.

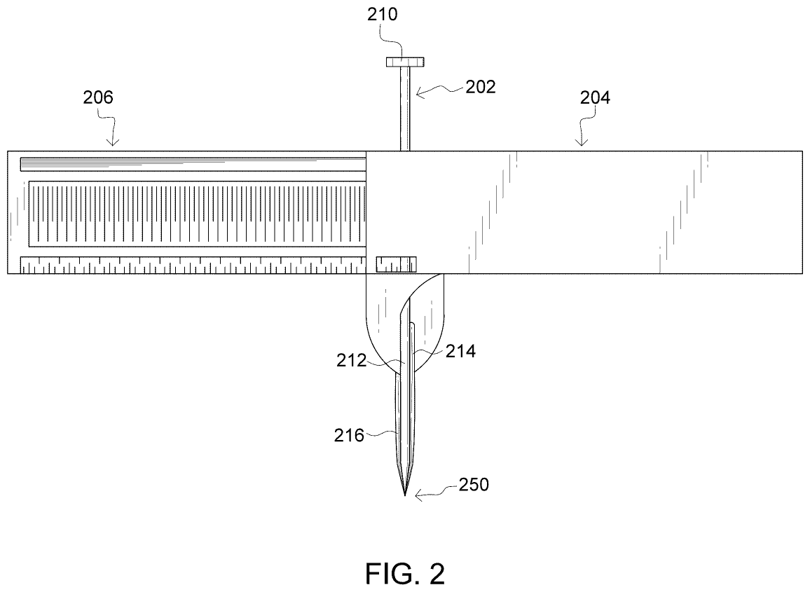

As shown, FIG. 2 illustrates a top plan view of a dental gauge, according to one embodiment of the invention. There is illustrated a bi-lateral adjustment mechanism 202 disposed between a pair of arms 204 and 206. The bi-lateral adjustment mechanism 202 includes an adjustment knob 210. A center post 212 is coupled to the adjustment knob 210 and extends therefrom. Side posts 214 and 216 are coupled to the pair of arms 204 and 206, respectively, and extend therefrom. The center post 212 and side posts 214 and 216 have end regions 250.

The illustrated pair of arms 204 and 206 slide relative to each other in lockstep such that a distance from each arm 204 and 206 to the center post 212 is the same. The adjustment mechanism 202 is functionally coupled between the pair of arms 204 and 206 to enforce the lockstep slide of the arms 204 and 206. For example, the adjustment mechanism 202 may be rotatably or slidably coupled to the arms 204 and 206. Accordingly, when the adjustment mechanism 202 is adjusted, the pair of side posts 214 and 216 each maintain the same distance from the center post 212 as the arms 204 and 206 slide.

Further shown, the pair of side posts 214 and 216 and the center post 212 each have an end region 250. The end regions 250 of the posts 212, 214, and 216 form a single continuous line. As the arms 204 and 206 are adjusted by the adjustment mechanism 202, the end regions 250 of side posts 214 and 216 slide linearly along this line in equal and opposite directions.

For instance, in one embodiment, if side post 214 slides to the left two centimeters, side post 216 slides to the right two centimeters. Likewise, if side post 214 slides to the right three centimeters, side post 216 slides to the left three centimeters. The center post 212 is fixed and the position of center post 212 remains stationary and constant as the arms 204 and 206 are adjusted.

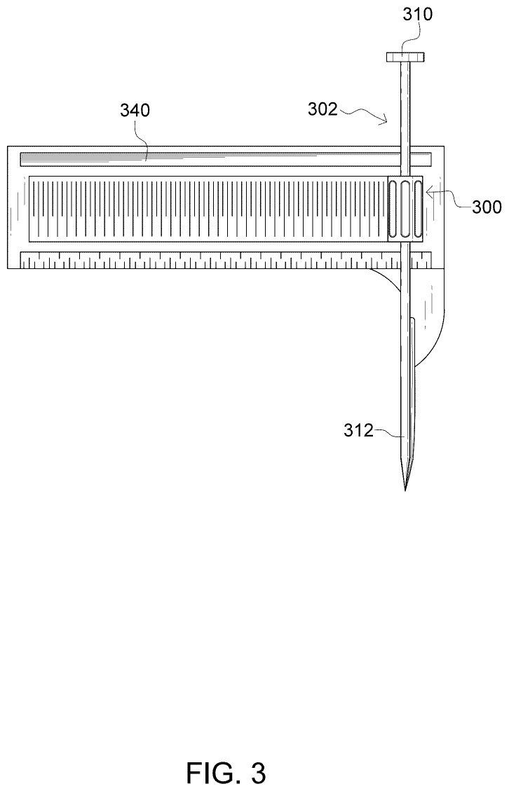

FIG. 3 illustrates a top plan view of a first arm of a dental gauge with a second arm removed, according to one embodiment of the invention. There is shown a gear with teeth 300. The gear 300 is part of the adjustment mechanism 302 and is coupled between the adjustment knob 310 and the center post 312. Further shown, the first arm includes a track 340. The track 340 may allow a first arm to coupled to a second arm, such as by tension- or snap-fit.

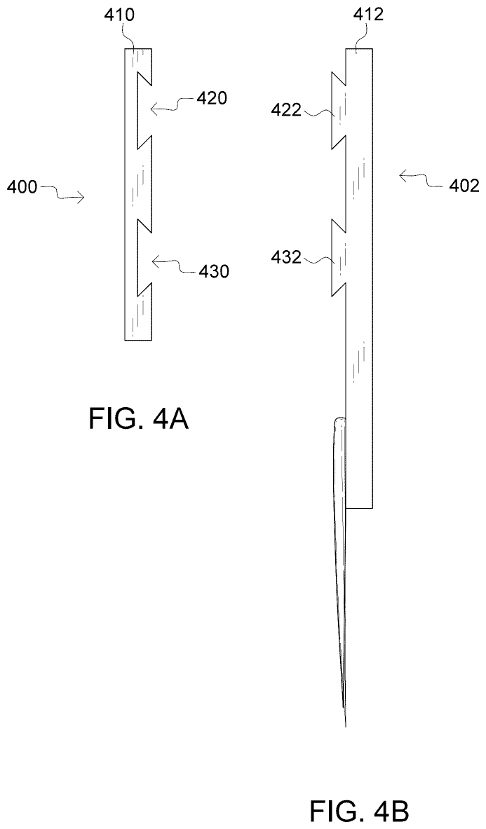

As shown, FIG. 4A illustrates a side elevational view of a first end of a first arm, according to one embodiment of the invention. There is illustrated a first end of a first arm 400 of a first front plate 410. The first front plate 410 includes a first female track 420 and a second female track 430.

FIG. 4B illustrates a side elevational view of a first end of a second arm, according to one embodiment of the invention. There is shown a first end of a second arm 402 of a first rear plate 412. The first rear plate 412 includes a first male track 422 and a second male track 432.

The first male track 422 and second male track 432 are sized and shaped to mate with the first female track 422 and the second female track 430, respectively. In one embodiment, the tracks 420, 422, 430, and 432 may be mated for securely and slidably coupling the first front plate 410 to the first rear plate 412. For example, the first front plate 410 and first rear plate 412 may slide side-to-side along the tracks 420, 422, 430, and 432.

The tracks 420, 422, 430, and 432 may have any size and/or shape for mating For example, the first male track 422 may have a trapezoidal profile for mating with the first female track 422 which may be shaped as a trapezoidal void. Accordingly, the tracks 420, 422, 430, and 432 may have a shape that is trapezoidal, triangular, and/or balloon-shaped. The tracks 420, 422, 430, and 432 may have any shape that has a narrow base and a wide top where a portion of one plate extends into a portion of another so that the plates are internally engaged and/or slide along the tracks 420, 422, 430, and 432 as the adjustment mechanism (see i.e., FIG. 1, item 102, FIG. 2, item 202, and FIG. 3, item 302). Further, the male tracks 420 and 430 may be any groove, slit, slot, track, indentation, cut, depression etc. for mating with the female tracks 422 and 432, and/or allowing the arms to slide. Likewise, the female tracks 422 and 432 may be any extension, protrusion, key, pin, fastener, etc. for mating with the male tracks 420 and 430, and/or allowing the arms to slide.

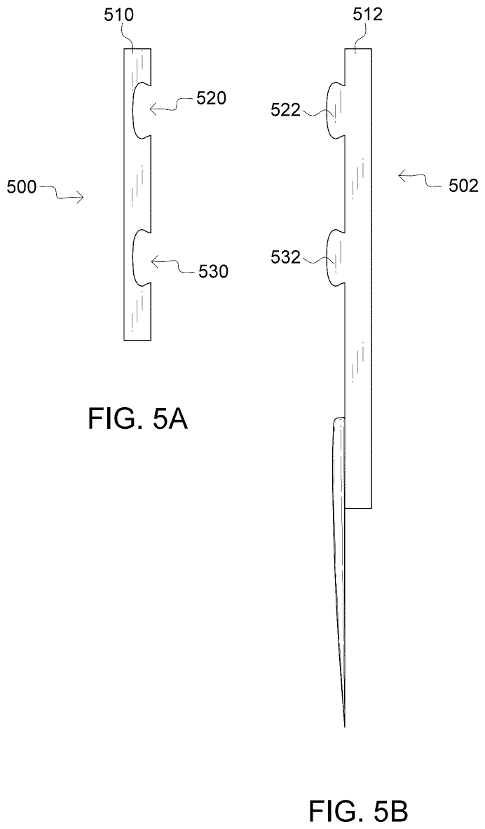

As shown, FIG. 5A illustrates a side elevational view of a first end of a first arm, according to one embodiment of the invention. There is illustrated a first end of a first arm 500 of a first front plate 510. The first front plate 510 includes a first female track 520 and a second female track 530.

FIG. 5B illustrates a side elevational view of a first end of a second arm, according to one embodiment of the invention. There is shown a first end of a second arm 502 of a first rear plate 512. The first rear plate 512 includes a first male track 522 and a second male track 532. The first male track 522 and second male track 532 are sized and shaped to slidably couple to the first female track 520 and the second female track 530, respectively.

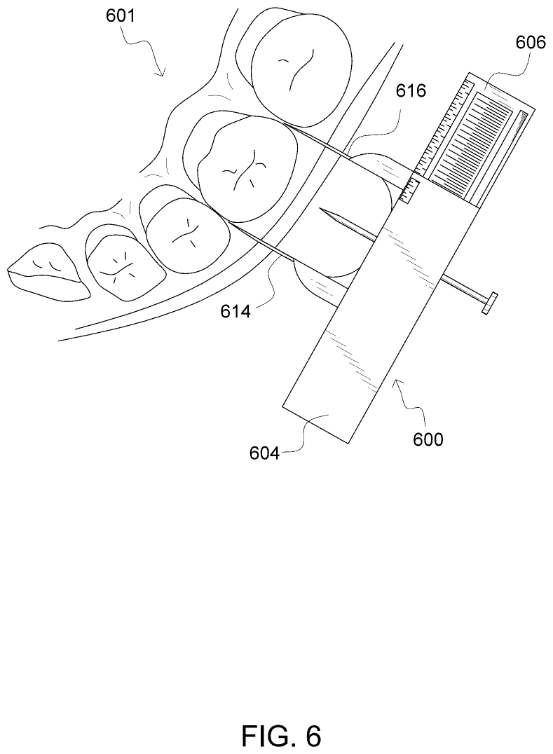

FIG. 6 illustrates a perspective view of a dental gauge, showing the dental gauge measuring a tooth, according to one embodiment of the invention. As shown, there is a dental gauge 600 in use, measuring a tooth 601. The dental gauge 600 also includes a first arm 604 and a second arm 606. The first arm 604 includes a first post 614 extending therefrom, and the second arm 606 includes a second post 616 extending therefrom. The first post 614 and the second post 616 are shown disposed about a tooth 601 for measuring the tooth 601. Accordingly, the dental gauge 600 may be adjusted along a tooth 601 for measuring.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures a gear with teeth coupled to an adjustment knob, the bi-lateral adjustment mechanism may be any mechanism that allows the first and second arm or pair of arms to slide in equal and opposite directions. Additionally, although the figures illustrate first and second posts or side posts for measuring, the device may not have posts, but laser lines for extending from the arms and spaced apart to measure distances.

It is also envisioned that the gauge may include a measuring device, such as a ruler or measuring stick, for measuring distances. The gauge may measure distances in millimeters, centimeters, inches, etc. Further, the gauge may include a digital measuring device for measuring distances digitally.

It is expected that there could be numerous variations of the design of this invention. An example is that the midline post or center post may have any shape that comes to a point or is clearly defined. Likewise, the first and second post or side posts may have any shape to abut the midline post or center post. Too, the posts may have any shape to engage a spacing or measuring line. For instance, the posts may be arrow-, triangular-, or pyramid-shaped. In one embodiment, the posts may taper or be tapered.

Finally, it is envisioned that the components of the device may be constructed of a variety of materials, such as metal, plastic, glass, rubber, wood, and so on.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A dental gauge configured to measure from a midline to a width of a contra-lateral tooth to determine symmetry, comprising:
a. a bi-lateral adjustment mechanism, including a first arm and a second arm functionally coupled to a selectably adjustable bi-lateral spacing adjustor that simultaneously adjusts a relative lateral positioning of each of the first arm and the second arm such that adjustments of the first and second arm are identical in amount and opposite in lateral direction;
b. a first post fixedly coupled to and extending from the first arm;
c. a second post fixedly coupled to and extending from the second arm; and
d. a midline post fixedly coupled to and extending from the bi-lateral adjustment mechanism such that adjustment of the mechanism does not change position of the midline post.

2. The dental gauge of claim 1, wherein the first post, second post, and midline post each have an end region, and wherein the end regions of the first post, second post, and midline post form a single continuous line.

3. The dental gauge of claim 1, wherein the bi-lateral adjustment mechanism includes an adjustment knob functionally coupled between the arms, such that turning the knob causes the arms to move in concert with one another.

4. The dental gauge of claim 3, wherein the bi-lateral spacing adjustor includes a gear with teeth functionally coupled to the knob and to the arms.

5. The dental gauge of claim 1, wherein the bi-lateral adjustment mechanism includes an adjustment knob with the midline post extending therefrom.

6. The dental gauge of claim 5, wherein the midline post includes a gear with teeth disposed thereon, wherein the gear is functionally coupled to the arms such that turning the knob causes the arms to move in concert with one another.

7. The dental gauge of claim 1, wherein the first arm includes a front plate, and the second arm includes a rear plate.

8. The dental gauge of claim 7, wherein the front plate includes a female track, and the rear plate includes a male track such that the front plate and the rear plate may be slidably coupled together.

9. The dental gauge of claim 8, wherein the front plate and the rear plate each include a track disposed along a surface of each plate, and wherein the selectably adjustable bi-lateral spacing adjustor includes a gear with teeth such that as the gear is turned, each plate slides a distance that is identical in amount and opposite in direction.

10. A dental gauge configured to measure from a midline to a width of a contra-lateral tooth to determine symmetry, comprising:
a. a pair of arms that slide relative to each other in lockstep such that their distance from a center post is each the same;
b. a pair of side posts each extending from one of the pair of arms and positioned such that both side posts maintain the same distance from the center post as the arms slide; and
c. an adjustment mechanism coupled between the pair of arms that enforces the lockstep slide of the pair of arms.

11. The dental gauge of claim 10, wherein the pair of side posts and the center post each have an end region, and wherein the end regions of the side posts and midline post form a single continuous line.

12. The dental gauge of claim 10, wherein the adjustment mechanism includes an adjustment knob functionally coupled between the arms, such that turning the knob causes the arms to move in concert with one another.

13. The dental gauge of claim 12, wherein the adjustment mechanism includes a gear with teeth functionally coupled to the knob and to the arms.

14. The dental gauge of claim 10, wherein the adjustment mechanism includes an adjustment knob with the center post extending therefrom.

15. The dental gauge of claim 14, wherein the center post includes a gear with teeth disposed thereon, wherein the gear is functionally coupled to the arms such that turning the knob causes the arms to move in concert with one another.

16. The dental gauge of claim 10, wherein a first arm includes a front plate, and a second arm includes a rear plate.

17. The dental gauge of claim 16, wherein the front plate includes a female track, and the rear plate includes a male track such that the front plate and the rear plate may be slidably coupled together.

18. The dental gauge of claim 17, wherein the front plate and the rear plate each include a track disposed along a surface of each plate, and wherein the adjustment mechanism includes a gear with teeth such that as the gear is turned, each plate slides a distance that is identical in amount and opposite in direction.

19. A dental gauge configured to measure from a midline to a width of a contra-lateral tooth to determine symmetry, comprising:
a. a bi-lateral adjustment mechanism, including:
i. a first arm and a second arm functionally coupled to a selectably adjustable bi-lateral spacing adjustor that simultaneously adjusts a relative lateral positioning of each of the first arm and the second arm such that adjustments of the first and second arm are identical in amount and opposite in lateral direction; and
ii. an adjustment knob functionally coupled between the arms, such that turning the knob causes the arms to move in concert with one another;
iii. wherein the bi-lateral spacing adjustor includes a gear with teeth functionally coupled to the knob and to the arms; and
iv. wherein the first arm includes a front plate, and the second arm includes a rear plate; wherein the front plate includes a female track, and the rear plate includes a male track such that the front plate and the rear plate may be slidably coupled together; wherein the front plate and the rear plate each include a track disposed along a surface of each plate;
b. a first post fixedly coupled to and extending from the first arm;
c. a second post fixedly coupled to and extending from the second arm; and
d. a midline post fixedly coupled to and extending from the adjustment knob of the bi-lateral adjustment mechanism such that adjustment of the mechanism does not change position of the midline post, wherein the first post, second post, and midline post each have an end region, and wherein the end regions of the first post, second post, and midline post form a single continuous line; wherein the midline post includes a gear with teeth disposed thereon, wherein the gear is functionally coupled to the arms, such that as the gear is turned, each plate slides a distance that is identical in amount and opposite in direction.
